(19) United States
(12) Patent Application Publication
(10) Pub. No.: US 2012/0164331 A1
(43) Pub. Date: Jun. 28, 2012

(54) METHOD FOR SPRAY PAINTING A RUBBER SHEET OR SURFACE

(76) Inventors: Fu Xiangzheng, Shengzhou City (CN); Pang Shuhua, Beijing (CN)

(21) Appl. No.: 13/111,598

(22) Filed: May 19, 2011

(30) Foreign Application Priority Data
Dec. 24, 2010 (CN) 201010603071.2

(51) Int. Cl. B05D 1/36

(52) U.S. Cl. 427/261; 427/258

(57) ABSTRACT

A method for spray painting a surface of a rubber sheet, particularly a black rubber sheet made from vulcanized crumb rubber produced from waste tires, includes the steps of overlaying a high-polymer substantial layer on the surface of the rubber sheet, and spray-painting any color photographs or designs preferably by a computer-controlled spray painting and, then, coating a wearable protective layer to improve the wear resistance and anti-oxidation on the spray painted layer. The method for spray painting a rubber sheet surface can be applied in manufacturing outdoor or indoor rubber floor carpets, ottomans, escalator carpet, tapestries and a wide range of other articles.

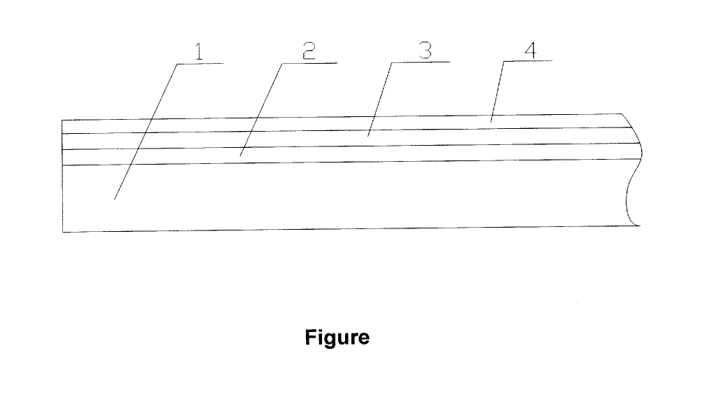

### BACKGROUND OF THE INVENTION

1. Technical Field of the Invention

The present invention relates, generally, to a method for spray painting a rubber surface, such as, for example, a rubber sheet.

More particularly, the present invention relates to a method for spray painting a rubber sheet, especially spray painting on a black rubber sheet made from vulcanized crumb rubber grinded from waste tire.

It is anticipated that the present invention can be widely applied for use in the manufacturing of outdoor and/or indoor rubber floor carpets, escalator carpets, rubber mats for a person's feet, tapestries, etc.

2. Description of the Prior Art

With the improvement and development of general economy conditions and the improvement of people's living standard, the quantity of motor vehicles grows rapidly. As a consequence used or worn out tires, and other waste rubber products, result in an increasingly more serious environmental problem requiring greater resources for attending to such problematic conditions. Annually, the number of used tires, or waste tires, worldwide numbers several billions. A manner of processing these waste tires and other waste rubber products into crumb rubber is an internationally recognized resource-recycling and hazard-free way to deal with the foregoing problem. However, such vulcanized crumb rubber is, primarily, an elastic black powder, so the products made from it are primarily black and having a simple color and poor appearance. Consequently, it has long been known to the state of the art that the recycled waste rubber (e.g., reclaimed rubber or crumb rubber) product as the representative of waste tires can only be utilized as industrial materials in the course of producing rubber products, but only rarely as final consumption, or retail, good for society, family or individual use.

More particularly, it is quiet difficult to dye the surface of the regenerated black rubber sheet and even more difficult for color topping designs. Such rubber sheets, when dyed, often result in coloring having poor color fastness, flexibility and abrasion resistance and, after only short-term use, will often exhibit color fading and off-coloring, which will compromise its aesthetic features.

### SUMMARY OF THE INVENTION

It is therefore an object of the present invention to provide a method for spray painting on a rubber sheet (or similar rubber surface), which results in a solid, well painted, combination of the rubber sheet and spray-painted coating.

The foregoing and related objects are accomplished by the present invention, which provides a method for spray printing on a rubber sheet, or similar rubber surface, which includes the steps of, initially, overlaying a high-polymer substantial layer on a rubber sheet, then spray painting one or more patterns on the high-polymer substantial layer. Thereafter, the method includes the step of overlaying a wearable (wear-resistant) protective layer on the spray-painted pattern(s).

The procedure adopted to overlay the high-polymer substantial layer can be spray coating, trowel coating or roller coating. Only after the high-polymer substantial layer has solidified can pictures or other patterns or designs be spray painted thereon.

The aforementioned rubber sheet can be reclaimed from black waste rubber.

The possible materials for use as the aforementioned high-polymer substantial layer can be selected from the group that includes polyurethanes (“PU”), amidoalkyd resin (“amino” or “AC”), unsaturated polyester resin (“PE” or “UP”) or epoxy resin (“EP”).

The preferred materials for spray painting can be any of the following: unsaturated polyester resin, photosensitive resin, amidoalkyd resin, flexible epoxy resin, urethanes or nitrate dope.

The material of the mentioned wearable/wear-resistant protective cover can preferably be any of the following: epoxy resin (“EP”), polyurethanes (“PU”), acrylic-polyester varnish or unsaturated polyester resin (“PE” or “UP”).

In summation, the present invention provides a method for effectively spray painting a rubber sheet, which overcomes the great difficulty of attempting to adequately dye or spray paint on recycled waster rubber. The result of the method of the invention is the production of finished rubber sheet products having, as so desired, various designs there-on, as well as optionally adding other aesthetic features and an anti-skid property. The finished products are also capable of being easily washed without damaging the spray painted coating. Upon the end of its useful life, the finished product within the scope of the invention can, itself, be recycled. The method of spray painting a rubber sheet or similar rubber surface can be utilized to produce indoor and/or outdoor rubber floor carpeting, ottomans, so-called escalator carpeting, tapestries and so forth.

Other objects and features of the present invention will become apparent when considered in combination with the accompanying drawing FIGURES which illustrate certain preferred embodiments of the present invention. It should, however, be noted that the accompanying drawing FIGURES are intended to illustrate only certain embodiments of the claimed invention and are not intended as a means for defining the limits and scope of the present invention.

### BRIEF DESCRIPTION OF THE DRAWING FIGURE

The single, unnumbered drawing FIGURE is a schematic diagram of a spray painted rubber sheet product produced in accordance with the method of the present invention.

### DETAILED DESCRIPTION OF THE PREFERRED EMBODIMENTS AND THE DRAWING FIGURE

The single, unnumbered drawing FIGURE is a schematic diagram of a spray painted rubber sheet finished product made in accordance with the method of the present invention, wherein a rubber sheet substrate 1 is shown, on top of which is a high-polymer substantial layer 2, then a color spray painted layer 3 and, finally, a wearable, or wear-resistant, protective cover 4.

The preferred components, or steps, of the inventive method for spray painting on a rubber sheet are as follows: first, overlay a light color, flexible, resistant-to-yellowing high-polymer substantial layer on a surface of a black reclaimed rubber sheet. The main technique feature of this substantial layer is to form an even coating with color affinity on the black rubber sheet, so as to improve the adhesivity to a color spray painted layer; then, spray-paint any color photograph or design by a wide variety of means, such as, e.g., by a computer auto-controlling spray-painter. Finally, overlay a wearable (or wear-resistant) protective coating on the spray painted color design(s), which make the painted pictures more endurable and resistant to oxidation.

The foregoing high-polymer substantial layer is, preferably, one of the following materials: urethanes (“PU”), amidoalkyd resin (“amino” or “AC”), unsaturated polyester resin (“PE” or “UP”) or epoxy resin (EP). The material of foregoing paint can be one of the following: unsaturated polyester resin, photograph sensitive resin, amidoalkyd resin, flexible epoxy resin, polyurethanes or nitrate dope. The nitrate dope can use the unsaturated styrene as the solvent and the material for spray-painting can be solvent ink. The material of the wearable/wear-resistant protective cover can be one of the following: epoxy resin (“EP”), polyurethanes (“PU”), acrylic-polyester varnish or unsaturated polyester resin (PE or UP). One can choose from these materials for each layer according to different occasions and purposes of rubber carpets or pads to make a finished product with multi-colorful layers.

The foregoing layers can apply spray coating, trowel coating or roller coating according to specific requirement of one practicing the method of the present invention. However, it is suggested that only after the painting material of the high polymer substantial layer has completely solidified should the operation be carried out to form the color spray painted layer and, after the painting material of the color spray-painted layer has solidified, should the manufacturer proceed to cover the wearable protective layer. The solidifying time ranges from 10 seconds to 30 minutes depending upon the type of dope, solidification and dilution agents. Each layer should preferably be even, but neither too thick nor too thin, thereby showing the pinhole(s) of the underlying layer.

The foregoing method of the present invention for color spray painting on rubber sheet to make a finished product, as showing in unnumbered drawing FIGURE it will be comprised by the sequent combination of: 1) rubber sheet substrate; 2) high-polymer substantial layer; 3) color spray painted layer; and, 4) wearable protective coating.

While only several embodiments of the present invention have been shown and described, it will be obvious to those skilled in the art that many modifications may be made to the present invention without departing from the spirit and scope thereof.

What is claimed is:

1. A method for spray painting on a rubber surface, comprising the steps of:
overlaying a high-polymer substantial layer on a rubber surface; and,
spray painting a pattern on said high-polymer substantial layer on said rubber surface.

2. The method for spray painting on a rubber surface according to claim 1, wherein said rubber surface is a surface of a rubber sheet.

3. The method for spray painting on a rubber surface according to claim 2, wherein said rubber sheet is a reclaimed rubber sheet made from waste black rubber.

4. The method for spray painting on a rubber surface according to claim 2, wherein said rubber sheet is made from vulcanized crumb rubber.

5. The method for spray painting on a rubber surface according to claim 1, further comprising the step of overlaying a wearable protective layer on said rubber surface after said spray painting step.

6. The method for spray painting on a rubber surface according to claim 5, wherein said wearable protective layer is made of a material selected from the group consisting of epoxy resin, polyurethane, acrylic-polyester varnish, unsaturated polyester resin and a combination thereof.

7. The method for spray painting on a rubber surface according to claim 1, wherein said step of overlaying a high-polymer substantial layer on a rubber surface is carried out spray coating the rubber surface after said high-polymer substantial layer has solidified, thereby allowing for a design to be spray painted on to said high-polymer substantial layer.

8. The method for spray painting on a rubber surface according to claim 1, wherein said step of overlaying a high-polymer substantial layer on a rubber surface is carried out trowel coating the rubber surface after said high-polymer substantial layer has solidified, thereby allowing for a design to be spray painted on to said high-polymer substantial layer.

9. The method for spray painting on a rubber surface according to claim 1, wherein said step of overlaying a high-polymer substantial layer on a rubber surface is carried out roller coating the rubber surface after said high-polymer substantial layer has solidified, thereby allowing for a design to be spray painted on to said high-polymer substantial layer.

10. The method for spray painting on a rubber surface according to claim 1, wherein said high-polymer substantial layer is made of a member selected from the group consisting of polyurethane, amidoalkyd resin, an unsaturated polyester resin, epoxy resin and a combination thereof.

11. The method for spray painting on a rubber surface according to claim 1, wherein said step of spray painting a pattern on said high-polymer substantial layer is carried out with a material used to paint the pattern that is selected from the group consisting of unsaturated polyester resin, photographic sensitive resin, amidoalkyd resin, flexible epoxy resin, polyurethane, nitrate dope and a combination thereof.
